(19) United States
(12) Patent Application Publication
(10) Pub. No.: US 2009/0091538 A1
(43) Pub. Date: Apr. 9, 2009

(54) Computer system and a method for determining whether a hot key is triggered

(75) Inventor: Wan-Chi Lan, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/153,638

(22) Filed: May 22, 2008

(30) Foreign Application Priority Data
Oct. 9, 2007 (TW) 096137918

(51) Int. Cl. G06F 3/02

(52) U.S. Cl. 345/172

(57) ABSTRACT

A computer system and a method for determining whether a hot key is triggered are disclosed. The method includes: querying a BIOS whether any hot key is triggered by a processing module every first interval time; querying the BIOS every second interval time if the BIOS replies there is any hot key being triggered, wherein the second interval time is shorter than the first interval time; querying the BIOS every first interval time if the query of the second interval time reaches a predetermined period and there is no hot key being triggered.

### BACKGROUND OF THE INVENTION

1. Field of the Invention

The present invention relates to a computer system and a method using the computer system for determining whether a hot key is triggered; and more particularly, to a computer system and a method for determining whether a hot key is triggered by setting flags and different querying interval times.

2. Description of the Related Art

Hot key, or shortcut key, is a key or a key combination disposed on a keyboard for quickly carrying out a function pre-defined by an application. For example, F1˜F12 keys can be configured to be hot keys to execute various pre-defined functions. If the application defines the F1 key to open a new window, then a user can open a new window by triggering (such as pressing) the F1 key on the keyboard, thereby saving the time for the user to input a instruction, click a menu or operate a mouse. Therefore, hot keys provide an efficient way for user to start an application in a shorter period of time.

However, there are some shortcomings in judging whether a hot key is triggered or not in the prior art. For example, the computer system may need to consume much computing power in detecting and determining whether a user has pressed a hot key or not. Hence, it will be advantageous if a new method is provided to accelerate the process in detecting and determining whether a user has pressed a hot key or not, it would improve the operation efficiency of the computer system.

### SUMMARY OF THE INVENTION

The present invention discloses a computer system and a method using the computer system for determining whether a hot key is triggered to accelerate the process in determining whether a hot key is triggered so as to solve the problems seen in the prior art.

The present invention provides a computer system, which comprises at least one hot key, a keyboard, a memory controller, a processing module and a basic input/output system (BIOS), wherein each hot key corresponds to an identification code. The keyboard controller is electrically coupled to at least one hot key and comprises a memory for saving the identification code corresponding to a hot key therein if the hot key is triggered. The BIOS is electrically coupled to the keyboard controller and the processing module, when the processing module queries the BIOS whether any hot key is triggered and if a hot key is triggered, the BIOS reads the identification code in the memory and reports the identification code to the processing module to inform the processing module that the hot key corresponding to the identification code is triggered, wherein the processing module queries the BIOS whether any hot key is triggered every first interval time; the processing module queries the BIOS every second interval time if a hot key is triggered, wherein the second interval time is shorter than the first interval time; the processing module queries the BIOS every first interval time if querying the BIOS whether any hot key is trigged every second interval time reaches a predetermined period and no hot key is triggered.

In an embodiment of the present invention, the processing module queries the BIOS system whether a hot key is triggered by a windows management instrumentation (WMI), particularly an advanced configuration and power interface (ACPI).

In an embodiment of the present invention, the memory is an embedded control random access memory (ECRAM) or an electrically erasable programmable read only memory (EEPROM).

In an embodiment of the present invention, the processing module comprises an application and the processing module queries the BIOS whether any hot key is triggered by the application.

Alternatively, the present invention provides a method for determining whether any hot key in a computer system is triggered, wherein the method comprises: setting a flag at an Input/Output (I/O) port by a keyboard controller to indicate whether any hot key is triggered; saving an identification code corresponding to the hot key in a memory if the flag indicates a hot key is triggered; querying a basic input/output system (BIOS) whether any hot key is triggered by a processing module; checking the flag by the BIOS; reading the identification code in the memory by the BIOS if the flag indicates a hot key is triggered; and reporting the identification code to the processing module by the BIOS to inform the processing module that the hot key corresponding to the identification code is triggered.

In an embodiment of the present invention, the processing module queries the BIOS whether any hot key is triggered, comprising: querying the BIOS whether any hot key is triggered every first interval time; querying the BIOS every second interval time if the BIOS replies there is a hot key being triggered, wherein the second interval time is shorter than the first interval time; and querying the BIOS every first interval time if querying the BIOS whether any hot key is trigged every second interval time reaches a predetermined period and the BIOS replies there is no hot key being triggered.

In an embodiment of the present invention, the first interval time is 1 second; the second interval time is 0.1 second; and the predetermined period is 1 second.

### BRIEF DESCRIPTION OF THE DRAWINGS

FIG. 1 illustrates a structural view in accordance with an embodiment of the present invention;

FIG. 2 is a flow chart illustrating a method for determining whether a hot key is triggered in accordance with the present invention; and

FIG. 3 is a flow chart illustrating a method for querying the BIOS whether a hot key is triggered by the processing module in accordance with the present invention.

### DETAILED DESCRIPTION OF THE PREFERRED EMBODIMENT

The advantages and innovative features of the invention will become more apparent from the following detailed description when taken in conjunction with the accompanying drawings.

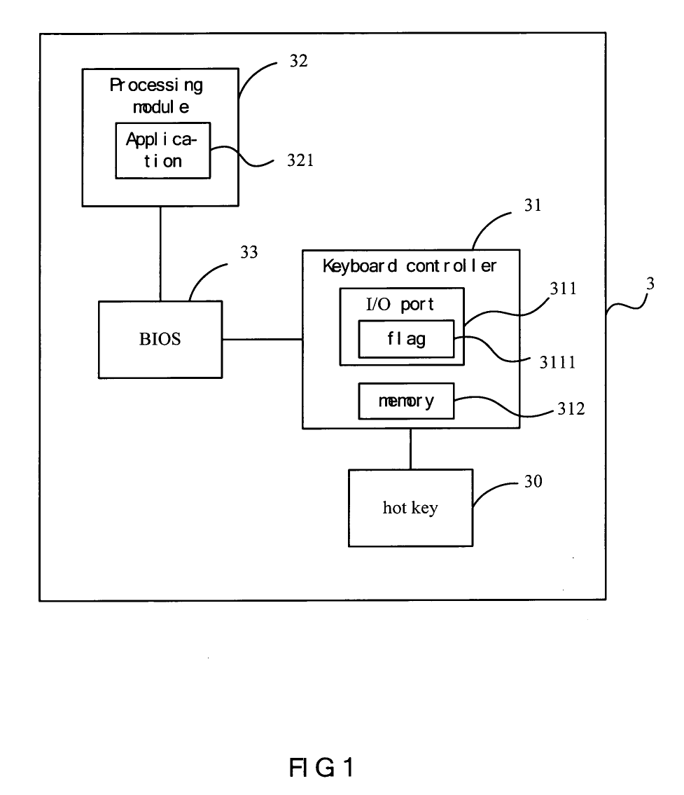

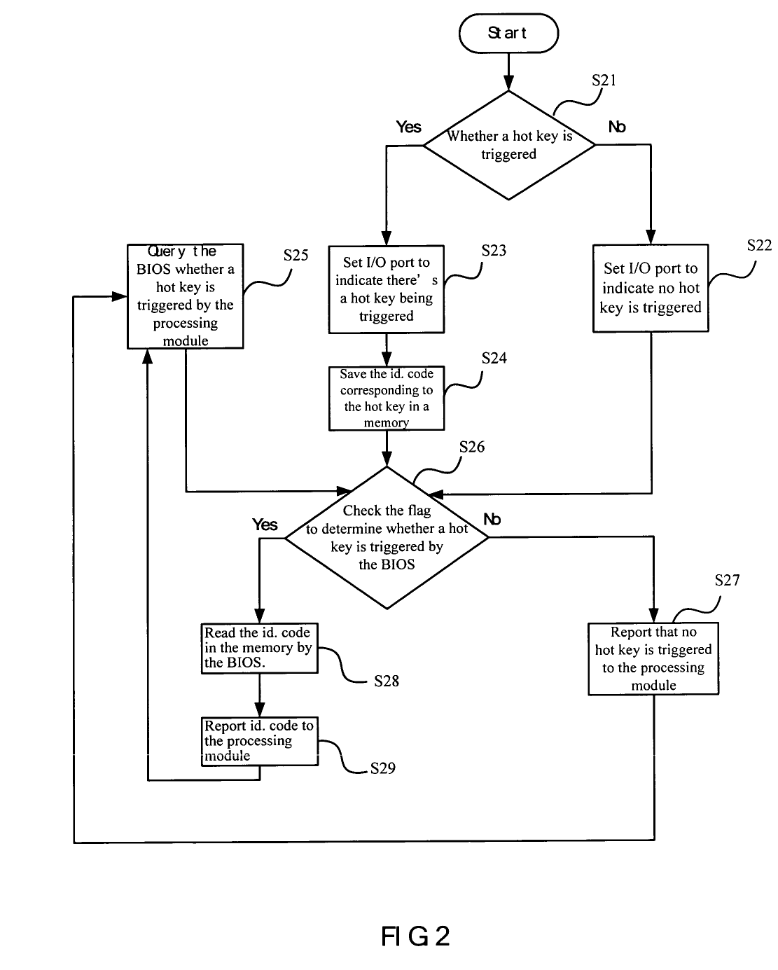

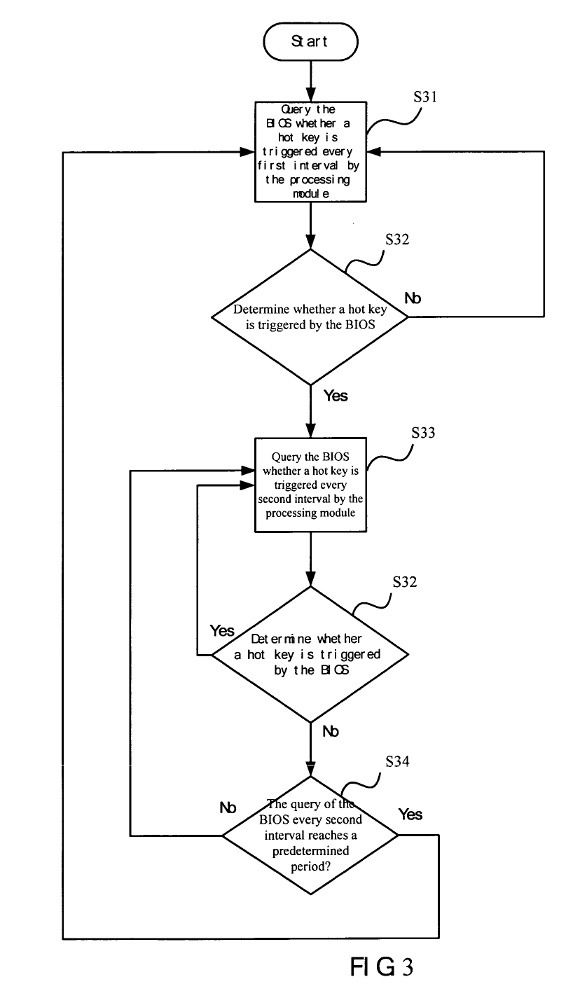

Please refer to FIG. 1, FIG. 2, and FIG. 3 for the computer system and the method using the computer system to determine whether a hot key is triggered in the present invention. FIG. 1 illustrates a structural view in accordance with an embodiment of the present invention. FIG. 2 and FIG. 3 are flow charts illustrating a method for determining whether a hot key is triggered in accordance with the present invention.

As shown in FIG. 1, the present invention provides a computer system 3, which comprises a hot key 30, a keyboard controller 31, a processing module 32 and a basic input/output system (BIOS) 33. It is noted that the computer system 3 can be, but not limited to, a desktop or a laptop, however, any device comprising the structure illustrated in FIG. 1 is in the scope of the computer system 3 of the present invention.

In an embodiment of the present invention, the hot key 30 is disposed on a keyboard (not shown in figure) for executing various pre-defined functions. For example, the hot key 30 can be, but not limited to, keys such as Fn, F1˜F12 or Fn+F1˜Fn+F12 on a regular keyboard. Each hot key 30 corresponds to a specific identification code for determining which hot key 30 is triggered by the user. It is noted that the user usually presses the hot key 30 to trigger the hot key 30, but there are different ways for the user to trigger the hot key 30.

The keyboard controller 31 is electrically coupled to the hot key 30 and comprises an I/O port 311 and a memory 312. The I/O port 311 comprises a flag 3111 to indicate whether a hot key 30 is triggered. In an embodiment of the present invention, the flag 3111 is represented by, but not limited to, a bit. When the user triggers a hot key 30, the keyboard controller 31 will set the flag 3111 to indicate a hot key 30 is triggered, for example, setting the bit value of the flag 3111 to be “1”; on the other hand, when the user does not trigger any hot key 30, the keyboard controller 31 will set the flag 3111 to indicate no hot key 30 is triggered, for example, setting the bit value of the flag 3111 to be “0”, but not limited to “0”. The memory 312 is used for saving the identification code corresponding to the hot key 30, when a hot key 30 is triggered; the identification code corresponding to the hot key 30 is saved in the memory 312. In an embodiment of the present invention, the memory 312 can be, but not limited to, an embedded control random access memory (ECRAM) or an electrically erasable programmable read only memory (EEPROM).

The processing module 32 is electrically coupled to the BIOS 33 and is used for querying the BIOS 33 whether any hot key 30 is triggered; if a hot key is triggered, then the processing module can execute the pre-defined function of the hot key 30. In an embodiment of the present invention, the processing module 32 comprises an application 321 for querying the BIOS 33 whether any hot key 30 is triggered, but the processing module 32 of the present invention can query the BIOS 33 by other schemes (such as circuitry, hardware, software, or the combination thereof). Furthermore, the application 321 can be, but not limited to, an application of an operating system.

The BIOS 33 is electrically coupled to the keyboard controller 31 and the processing module 32. When the processing module 32 queries the BIOS 33 whether any hot key 30 is triggered, then the BIOS 33 checks the flag 3111 to determine whether any hot key 30 is triggered. If the flag 3111 indicates that any hot key 30 is triggered (that is, the bit value is “1”), then the BIOS 33 reads the identification code in the memory 312 and reports the identification code to processing module 32. Therefore, the processing module 32 knows the hot key 30 corresponding to the identification code is triggered and then execute the pre-defined function of the hot key 30. In an embodiment of the present invention, the processing module 32 queries the BIOS 33 whether any hot key 30 is triggered by, but not limited to, windows management instrumentation (WMI), particularly an advanced configuration and power interface (ACPI), alternatively, the processing module 32 can query the BIOS 33 by interrupt (INT15). As to how the processing module 32 queries the BIOS 33 and how the BIOS 33 knows whether a hot key 30 is triggered, the details will be described below.

Next, please refer to FIG. 2 and FIG. 3 for the flow charts of the method in the present invention for determining a hot key is triggered. It is noted that the order of the steps are not limited to as illustrated in FIG. 2 and FIG. 3, other step orders can be adopted to achieve the same object or the similar result.

Following is the steps of the present invention illustrated by the computer system 3 in FIG. 1, it is noted that the present invention is not limited to the method in cooperation of the computer system 3 in FIG. 1.

Please refer to FIG. 2, the present invention starts from step S21: determining whether any hot key 30 is triggered by a keyboard controller 31.

In step S21, the keyboard controller 31 determines whether any hot key 30 is triggered (for example, pressed) by a user. If there's no hot key 30 being triggered by a user, then the keyboard controller 31 goes to step S22; if there's a hot key 30 being triggered by a user, then the keyboard controller 31 goes to S23.

If there's no hot key 30 being triggered by a user, then the keyboard controller 31 goes to step S22: setting the flag of the I/O port to indicate that no hot key is triggered.

In an embodiment of the present invention, the present invention sets “no hot key is triggered” as the pre-set state of the flag 3111, that is, the bit value of the flag is set to, but not limited to, the value of “0”. Therefore, if there's no hot key 30 being triggered by a user in step S21, then in step S22, the state of the flag 3111 is kept to be “0”, which means there's no hot key 30 being triggered.

If there's a hot key 30 being triggered by a user, then the keyboard controller 31 goes to S23: setting the flag of the I/O port to indicate a hot key is triggered. In an embodiment of the present invention, the present invention sets “no hot key is triggered” as the pre-set state of the flag 3111, that is, the bit value of the flag is set to, but not limited to, the value of “0”. Therefore, if there's a hot key 30 being triggered by a user in step S21, then in step S23, the state of the flag 3111 is updated to be “1”, which means a hot key 30 is triggered.

After step S23 is done, the present invention proceeds to step S24: saving the identification code corresponding to the hot key in a memory.

As described above, each hot key 30 corresponds to a different identification code, therefore, after step S23 is done, the present invention proceeds to step S24 and saves the identification code corresponding to the triggered hot key 30 in the memory 312 of the keyboard controller 31 for later processing.

It is noted that steps S21˜S24 in the present invention are carried out by the keyboard controller 31 for the BIOS 33 to determine whether any hot key 30 is triggered and which hot key is triggered. The BIOS 33 determines whether any hot key is triggered to respond to the query of the processing module 32. Therefore, the following descriptions are related to how the processing module 32 queries the BIOS 33 and how the BIOS 33 determines and reports the result.

First, the present invention proceeds to S25; querying whether any hot key is triggered by the processing module 32.

In step S25, the processing module 32 queries the BIOS 33 whether any hot key 30 is triggered by an application 321. In an embodiment of the present invention, the processing module 32 queries the BIOS 33 whether any hot key is triggered by, but not limited to, the WMI, particularly the ACPI, alternatively, the processing module 32 can query the BIOS 33 by INT15.

When the BIOS 33 is queried by the processing module 32, the present invention proceeds to step S26: checking the BIOS for the state of the flag to determine whether any hot key is triggered.

In step S26, the BIOS 33 checks the state of the flag 3111 set in step S22 or step S23 to determine whether any hot key 30 is triggered. If no hot key 30 is triggered, that is, the bit value of the flag 3111 is “0”, then the present invention proceeds to step S27; if there's a hot key 30 being triggered, that is, the bit value of the flag 3111 is “1”, then the present invention proceeds to step S28.

If no hot key 30 is triggered, then the present invention proceeds to step S27: reporting to the processing module 32 that no hot key is triggered.

In step S27, the BIOS 33 reports that no hot key is triggered to the processing module 32 by the WMI, particularly the ACPI, or INT15.

If in step S26 it is determined that any hot key 30 is triggered, then the present invention proceeds to S28: reading the identification code in the memory by the BIOS.

In step S28, the BIOS 33 reads the identification code saved in the memory 312 in step S24 to know which hot key 30 is triggered.

According to steps S21˜S28, when the processing module 32 queries the BIOS 33, the BIOS 33 checks the flag 3111 to determine whether any hot key 30 is triggered. The BIOS 33 only reads the identification code in the memory 312 when any hot key 30 is triggered, therefore the BIOS 33 doesn't need to read the data in the memory 312 every time the processing module 32 queries the BIOS 33, the determining and reporting time of the BIOS 33 are shortened.

After step S28 is done, the present invention proceeds to S29: reporting the identification code to the processing module. Therefore the processing module 32 knows the hot key 30 corresponding to the identification code is triggered and then executes the pre-defined function of the hot key 30.

In an embodiment of the present invention, the processing module 32 continually queries the BIOS 33 whether any hot key is triggered, so after step S27 or step S29, the present invention goes back to S25 and queries the BIOS 33 whether any hot key 30 is triggered by the processing module 32. As to the method of the processing module 32 for querying the BIOS 33 whether any hot key 30 is triggered, details will be described below.

Then please refer to FIG. 3 for the flow chart of the processing module in the present invention for querying the BIOS whether any hot key is triggered.

In FIG. 3, the present invention first goes to step S31: the processing module querying whether any hot key is triggered every first interval time.

In step S31, the processing module 32 queries the BIOS 33 whether any hot key is triggered by an application 321 every first interval time. In an embodiment of the present invention, the first interval time is 1 second, but not limited to 1 second.

Later, the present invention proceeds to S32: determining whether any hot key is triggered by the BIOS.

In step S32, the BIOS 33 executes steps S26˜S29 in FIG. 2 to determine whether any hot key 30 is triggered. If the BIOS determines there's no hot key 30 being triggered, then the present invention repeats step S31 to query the BIOS 33 whether any hot key 30 is triggered by the processing module 32 every first interval time. If the BIOS 33 determines there's a hot key 30 being triggered, then the present invention proceeds to S33: querying the BIOS whether any hot key 30 is triggered by the processing module every second interval time.

Generally, if a user triggers a hot key, then it is likely that the user may trigger the hot key again in a very short time. For example, if the function of the hot key is to adjust volume, then the user may trigger the hot key for many times in a short period to adjust the volume to a desire level. Therefore, since in step S32 the BIOS 33 reports a hot key 30 is triggered, then in step S33, the processing module 32 of the present invention queries the BIOS 33 whether any hot key is triggered every second interval time (for example, 0.1 second), which is shorter than the first interval time (for example, 1 second), for determining whether the user triggers a hot key 30 in a short time. It is noted that the second interval time is not limited to 0.1 second; the second interval time only needs to be shorter than the first interval time in the present invention.

The processing module 32 queries the BIOS 33 whether any hot key 30 is triggered in step S33 every second interval time, then the present invention goes back to S32 again: determining whether any hot key is triggered by the BIOS. If the BIOS 33 determines any hot key 30 is triggered, then the present invention proceeds to S33: querying the BIOS whether any hot key 30 is triggered by the processing module every second interval time. If the BIOS 33 determines there's no hot key 30 being triggered, then the present invention proceeds to step S34: determining if querying the BIOS every second interval time has reached a predetermined period.

Generally, if the user triggers a hot key, then after a predetermined period the user still doesn't trigger a hot key, then it is not likely that the user will trigger a hot key in a very short time. For example, when the function of a hot key is to adjust volume, when the user triggered the hot key once or twice and did not trigger the hot key again for a predetermined period, that means the user may have adjust the volume by the hot key to a desired level and does not need to adjust the volume again. Therefore, since the processing module queries the BIOS 33 whether any hot key is triggered every second interval time and the BIOS 33 reports no hot key 30 is triggered, then in step S34, the present invention determines if querying the BIOS 33 every second interval time has reached a predetermined period, such as 1 second, but not limited to 1 second. If yes, it means that the user may not trigger the hot key 30 again in a short time and it's not necessary to query the BIOS 33 every second interval time, the processing module can now queries the BIOS 33 only every first interval time to prevent the system resource of the computer system 3 from overly consumed by frequent queries. Therefore, if it is determined in S34 that the a predetermined period has expired, then the present invention goes to step S31 and queries the BIOS 33 whether any hot key 30 is triggered only every first interval time; if not, then the present invention goes to S33 and keeps querying the BIOS 33 whether any hot key 30 is triggered every second interval time.

It is noted that the above-mentioned embodiments are only for illustration, it is intended that the present invention cover modifications and variations of this invention provided they fall within the scope of the following claims and their equivalents. For example, the flag 3111 and the memory 312 can be disposed outside the keyboard controller 31. Therefore, it will be apparent to those skilled in the art that various modifications and variations can be made to the structure of the present invention without departing from the scope or spirit of the invention.

What is claimed is:

1. A method for determining whether a hot key is trigged to determine whether any hot key in a computer system is triggered, the method comprising:
setting a flag at an Input/Output (I/O) port by a keyboard controller to indicate whether any hot key is triggered;
saving an identification code corresponding to a hot key in a memory if the flag indicates that any hot key is triggered;
querying a basic input/output system (BIOS) whether any hot key is triggered by a processing module;
checking the flag by the BIOS;
reading the identification code in the memory by the BIOS if the flag indicates that any hot key is triggered; and
reporting the identification code to the processing module by the BIOS to inform the processing module that the hot key corresponding to the identification code is triggered.

2. The method as claimed in claim 1, wherein the step of querying the BIOS whether any hot key is triggered by a processing module comprises:
querying the BIOS whether any hot key is triggered every first interval time; and
querying the BIOS every second interval time if the BIOS replies that any hot key is triggered, wherein the second interval time is shorter than the first interval time.

3. The method as claimed in claim 2 further comprising:
querying the BIOS every first interval time if querying the BIOS whether any hot key is trigged every second interval time reaches a predetermined period and the BIOS replies there is no hot key being triggered.

4. The method as claimed in claim 2, wherein the first interval time is 1 second and the second interval time is 0.1 second.

5. The method as claimed in claim 3, wherein the predetermined period is 1 second.

6. The method as claimed in claim 1, wherein the processing module queries the BIOS system whether any hot key is triggered by a windows management instrumentation (WMI).

7. The method as claimed in claim 1, wherein the processing module queries the BIOS system whether any hot key is triggered by an advanced configuration and power interface (ACPI).

8. The method as claimed in claim 1, wherein the processing module comprises an application and the processing module queries the BIOS whether any hot key is triggered by the application.

9. A method for determining whether a hot key is trigged to determine whether any hot key in a computer system is triggered, wherein the method comprises:
querying a basic input/output system (BIOS) whether any hot key is triggered by a processing module every first interval time;
querying the BIOS every second interval time if the BIOS replies that any hot key is triggered, wherein the second interval time is shorter than the first interval time; and
querying the BIOS every first interval time if querying the BIOS whether any hot key is trigged every second interval time reaches a predetermined period and the BIOS replies there is no hot key being triggered.

10. The method as claimed in claim 9, wherein the step of querying the BIOS whether any hot key is triggered comprises:
setting a flag at an Input/Output (I/O) port by a keyboard controller to indicate whether any hot key is triggered;
saving an identification code corresponding to a hot key in a memory if the flag indicates the hot key is triggered;
checking the flag by the BIOS;
reading the identification code in the memory by the BIOS if the flag indicates that any hot key is triggered; and
reporting the identification code to the processing module by the BIOS to inform the processing module that the hot key corresponding to the identification code is triggered.

11. The method as claimed in claim 9, wherein the first interval time is 1 second and the second interval time is 0.1 second.

12. The method as claimed in claim 9, wherein the predetermined period is 1 second.

13. The method as claimed in claim 9, wherein the processing module queries the BIOS system whether any hot key is triggered by a windows management instrumentation (WMI).

14. The method as claimed in claim 9, wherein the processing module queries the BIOS system whether any hot key is triggered by an advanced configuration and power interface (ACPI).

15. The method as claimed in claim 9, wherein the processing module comprises an application and the processing module queries the BIOS whether any hot key is triggered by the application.

16. A computer system comprising:
at least one hot key, wherein each hot key corresponds to an identification code;
a keyboard controller electrically coupled to the at least one hot key, the keyboard controller comprising:
a memory for saving the identification code corresponding to a hot key therein if the hot key is triggered;
a processing module; and
a basic input/output system (BIOS) electrically coupled to the keyboard controller and the processing module, when the processing module queries the BIOS whether any hot key is triggered and if any hot key is triggered, the BIOS reads the identification code in the memory and reports the identification code to the processing module to inform the processing module that the hot key corresponding to the identification code is triggered, wherein the processing module queries the BIOS whether any hot key is triggered every first interval time; the processing module queries the BIOS every second interval time if any hot key is triggered, wherein the second interval time is shorter than the first interval time; the processing module queries the BIOS every first interval time if querying the BIOS whether any hot key is trigged every second interval time reaches a predetermined period and no hot key is triggered.

17. The computer system as claimed in claim 16, wherein the keyboard controller comprises an input/output (I/O) port, and the I/O port sets a flag to indicate whether any hot key is triggered.

18. The computer system as claimed in claim 16, wherein the processing module queries the BIOS system whether any hot key is triggered by a windows management instrumentation (WMI).

19. The computer system as claimed in claim 16, wherein the processing module queries the BIOS system whether any hot key is triggered by an advanced configuration and power interface (ACPI).

20. The computer system as claimed in claim 16, wherein the processing module comprises an application and the processing module queries the BIOS whether any hot key is triggered by the application.
